(19) United States
(12) Patent Application Publication
(10) Pub. No.: US 2012/0002305 A1
(43) Pub. Date: Jan. 5, 2012

(54) DIAGONAL MIRROR WITH DISPLAY

(76) Inventor: WILLIAM YANG, TAIPEI (TW)

(21) Appl. No.: 12/830,355

(22) Filed: Jul. 5, 2010

(51) Int. Cl. G02B 7/18; G02B 7/02

(52) U.S. Cl. 359/811

(57) ABSTRACT

A diagonal mirror having a display includes a minor holder and a display detector. The mirror holder has a main body, an ocular part connected to the main body in tilt way, and a telescope tube connector connected to the main body in a way that is tilt relative to the main body and diagonal to the lens holder. One side of the main body has a hole. The display detector inlayed in the hole on the side of the mirror holder is used to detect and show the surrounding area conditions. Users could directly get information of outdoor surrounding area from the display detector. With the information of outdoor surrounding area, users could precisely adjust the focusing system of the telescope and have a clear magnified visual image of the astronomy landscape.

### BACKGROUND OF THE INVENTION

1. Field of the Invention

The present invention relates to a telescope diagonal mirror with a display which could show the condition of the surrounding area.

2. Description of Related Art

A telescope could be generally classified into a monocular telescope and a binocular telescope. Users could watch a magnified image of the observed object through an optical path created by a plurality of optical lens installed inside a telescope. Users need to search the object with their naked-eyes in advance, then, use the object lens side to aim the object and adjust the focusing system till the users could have clear visual of the object. The telescope could be used for astronomy observation, watching wild animals or objects far away. The astronomical telescope mainly has a telescope tube and a diagonal mirror at one end of the telescope tube. Users would have a comfortable feeling in long time astronomy landscape observation with the elevation ocular created by the design of the diagonal mirror.

However, the astronomical telescope is mainly used outdoor at night. Users usually need to have more information of observing condition, since the focusing error would be occurred by the thermal expansion of the lens. The thermal expansion of the lens is usually occurred by the change of moisture, temperature or altitude position. Once users don't have the display detector with them, they would not have sufficient information of the surrounding area and would not have precise value for adjusting the focusing system of the telescope. Therefore, a display detector is necessary equipment to telescope users. The present invention is designed to improve the shortage mentioned above.

### SUMMARY OF THE INVENTION

The present invention provides a diagonal mirror having a display detector which is able to detect the conditions of surrounding area. The users could easily get the information of surrounding area and precisely adjust the focusing system of the telescope for astronomical landscape observation.

In order to achieve the aforementioned objectives, according to an embodiment of the present invention, a diagonal mirror with a display includes a mirror holder and a display detector.

The mirror holder has a main body, an ocular connected to the main body in tilt way, and a telescope connector connected to the main body in a way that is tilt relative to the main body and diagonal to the lens holder. One side of the main body has a hole. The display detector inlayed in the hole on the side of the mirror holder is used to detect and show the surrounding area conditions.

The present invention has following benefits. Users could directly get information of outdoor surrounding area with the display detector inlayed on the main body of the diagonal mirror. With the information displayed on the display detector, users could precisely adjust the focusing system of the telescope and have a clear magnified visual image of the astronomy landscape.

In order to have further understanding of the present invention, the following embodiments are provided along with illustrations to facilitate the disclosure of the present invention.

### BRIEF DESCRIPTION OF THE DRAWINGS

FIG. 1 shows a 3D exploded view of the present invention;

FIG. 2 shows a 3D assembled view of the present invention;

FIG. 3 is a side view of the present invention;

FIG. 4 is a 3D assembled view of another preferred embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

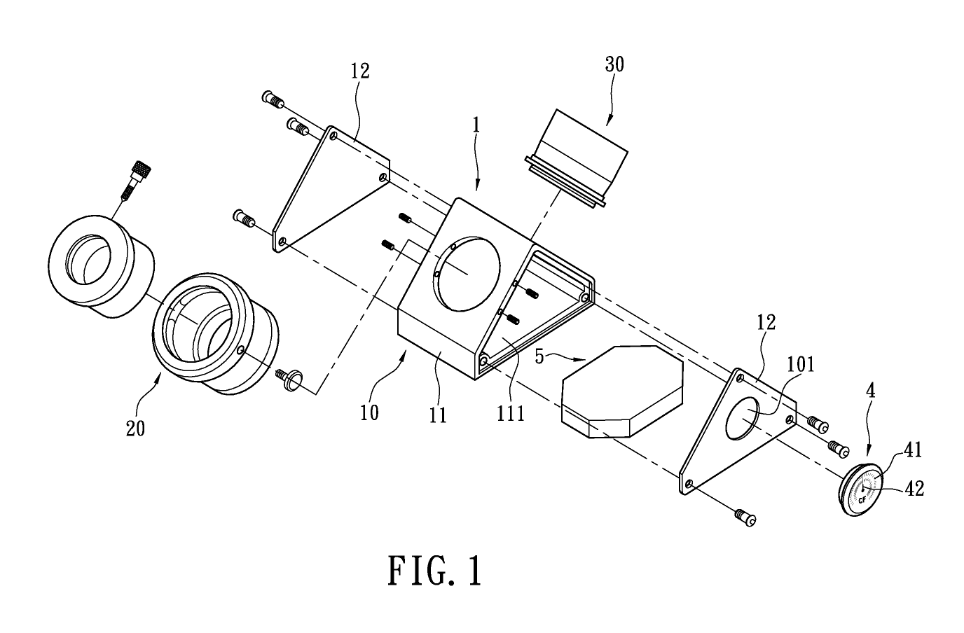

The present invention provides a diagonal mirror with a display detector connected to a telescope tube and users could comfortably observe the astronomy landscape with the elevation ocular. As shown in FIG. 1, the diagonal mirror includes a mirror holder 1 and a display detector 4.

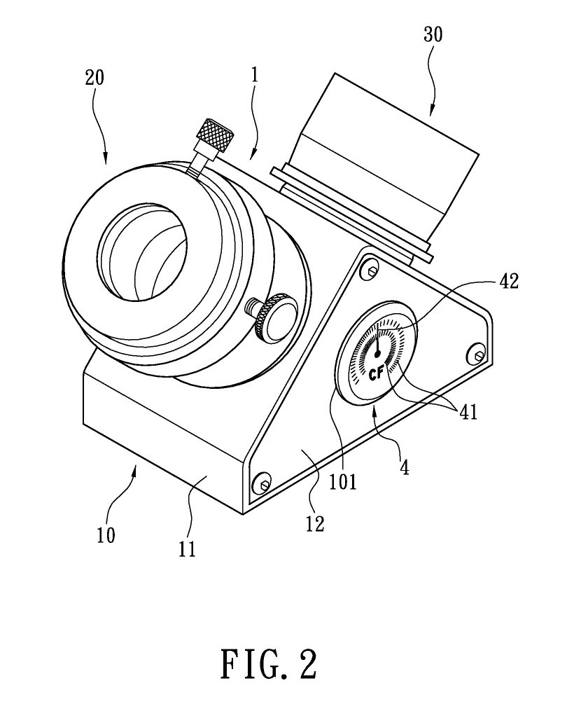

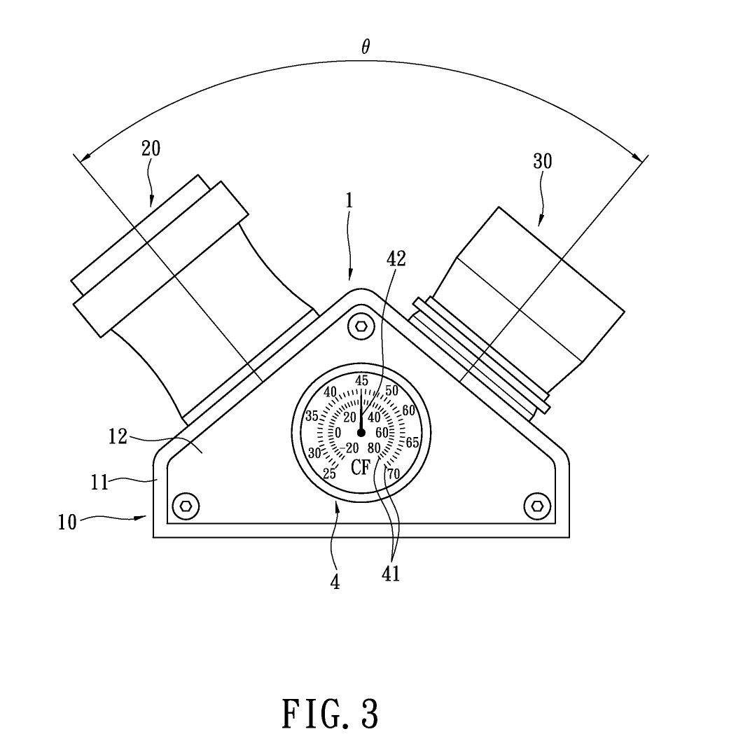

From FIG. 1 to FIG. 3, the mirror holder 1 has a main body 10, an ocular part 20 and a telescope tube connector 30. The main body 10 has a hollow structure for accommodating a reflector 5. One side of the main body 10 has a hole 101. The ocular part 20 is connected to the main body 10 in a tilt way. The telescope tube connector 30 is connected to the main body 10 in a way that is tilt relative to the main body 10 and diagonal to the ocular part 20. The angle θ between the ocular part 20 and the telescope tube connector 30 is 90 degrees, as shown in FIG. 3. The ocular part 20 has a hollow structure which could receive optical lens, not shown.

The display detector 4 has a display panel which shows the value of all conditions around, such as temperature, moisture, and altitude position. The display panel of display detector 4 could be a digital type display panel or an indicator type display panel. In one embodiment of the present invention, an indicator type display panel which has a dial scale 41, and an indicator 42. The indicator 42 is able to rotate counterclockwise or clockwise for indicating the corresponding value of the surrounding area conditions on the dial scale 41.

The aforementioned display detector 4 located at one side of the mirror holder 1 is inlayed into the hole 101 of the mirror holder 1. Therefore, after the mirror holder 1 is assembled with a telescope, not shown in the figure, through the telescope tube connector 30, users could know all surrounding area conditions via the display detector at the side of the mirror holder 1.

On the other hand, as shown in FIG. 1 through FIG. 3, is the first preferred embodiment of the present invention. The main body 10, the ocular part 20 and the telescope tube connector 30 could be individual component which differ from one another. The ocular part 20 and the telescope tube connector 30 could be separately screwed onto or attached to opposite tilt walls of the main body 10. The main body 10 could further have two side plates 12, and a hollow corner block seat 11 with two openings 111 at its opposite ends. The hole 101 is located on one of the side plates 12 which are assembled to the sides of the corner block seat 11 to cover the corresponding openings 111. The ocular part 20 and the telescope tube connector 30 are fastened onto opposite tilt walls of the corner block seat 11. The second embodiment of the present invention is almost same as the first embodiment, except that the main body 10 is integrally formed with the ocular part 20, and the telescope tube connector 30 is screwed onto or attached to one of the opposite tilt walls of the corner block seat 11. The ocular part 20 is an extended part outward from another tilt wall of the corner block seat 11.

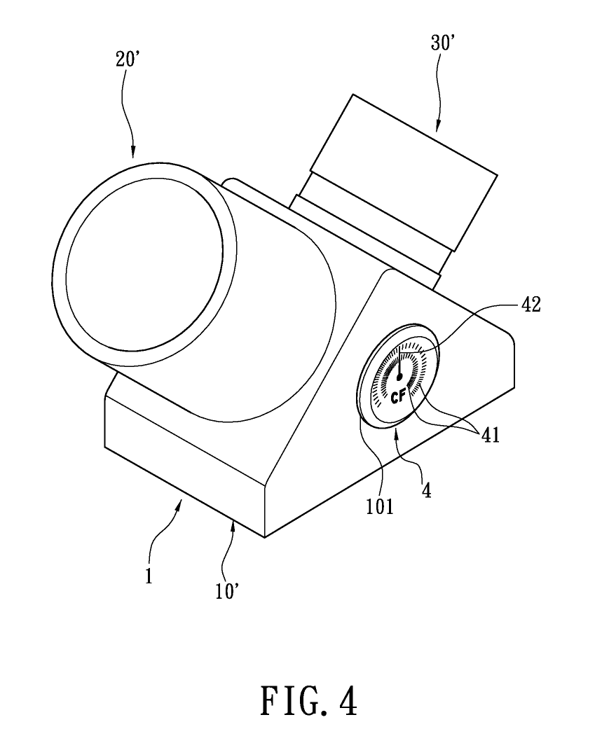

In FIG. 4 is the third embodiment of the present invention having a main body 10′, an ocular part 20′ and a telescope tube connector 30′ are integrally formed. The ocular part 20′ and the telescope tube connector 30′ are individually extended from their corresponding tilt walls of the main body 10′.

In light of the above, the integrity of the ocular part with the display detector which can show the surrounding conditions allows the user to directly read all information about the surroundings area while users are using the telescope. Therefore, users could easily have the information of the surrounding area and have precise control of the focusing system of the telescope. Then, users could have clear visual image of the astronomy landscape.

The descriptions illustrated supra set forth simply the preferred embodiments of the present invention. However, the characteristics of the present invention are by no means restricted thereto. All changes, alternations, or modifications conveniently considered by those skilled in the art are deemed to be encompassed within the scope of the present invention delineated by the following claims.

What is claimed is:

1. A diagonal mirror having a display, comprising:
a mirror holder, having a main body, a lens holder connected to the main body in tilt way, and a telescope connector connected to the main body in a way that is tilt relative to the main body and diagonal to the lens holder, wherein one side of the main body has a through hole; and
a detector display, used to show surrounding conditions and embedded in the through hole of the mirror holder to position at the side of the mirror holder.

2. The diagonal mirror according to claim 1, wherein the detector display is an electronic display able to show the values of temperature and moisture.

3. The diagonal mirror according to claim 1, wherein the detector display is a dial indicator able to show the values of temperature and moisture.

4. The diagonal mirror according to claim 1, wherein the main body, the lens holder and the telescope connector are individual to one another, and the lens holder and the telescope connector are separately engaged with, screwed onto or attached to opposite the corresponding tilt walls of the main body in screwing manner.

5. The diagonal mirror according to claim 4, wherein the main body has two side plates, and a hollow angled seat with two openings at its opposite ends; the through hole is formed on one of the side plates which are assembled to the sides of the angled seat to cover the corresponding openings; the lens holder and the telescope connector are fastened onto opposite tilt walls of the angled seat in screwing manner.

6. The diagonal mirror according to claim 1, wherein the main body is integrally formed with the lens holder; the telescope connector is engaged with, screwed onto or attached to one of the tilt walls of the angled seat; and the lens holder extends outward from the other of the tilt walls of the angled seat.

7. The diagonal mirror according to claim 5, wherein the main body has a hollow angled seat with two openings at its opposite ends; the through hole is formed on one of the side plates which are assembled to the sides of the angled seat to cover the corresponding openings; the telescope connector is engaged onto one of the tilt walls of the angled seat; and the lens holder extends outward from the other of the tilt walls of the angled seat.

8. The diagonal mirror according to claim 1, wherein the main body, the lens holder and the telescope connector are integrally formed, and the lens holder and the telescope connector respectively extend from the corresponding tilt walls of the main body.
